(19) United States
(12) Patent Application Publication
(10) Pub. No.: US 2020/0006960 A1
(43) Pub. Date: Jan. 2, 2020

(54) CHARGING DEVICE AND METHOD THEREOF

(71) Applicant: GETAC TECHNOLOGY CORPORATION, Hsinchu County (TW)

(72) Inventor: Chen-Fu HUANG, Taipei City (TW)

(21) Appl. No.: 16/022,479

(22) Filed: Jun. 28, 2018

(51) Int. Cl. H02J 7/00

(52) U.S. Cl. CPC H02J 7/0021; H02J 7/007

(57) ABSTRACT

A charging method includes: measuring a plurality of battery voltages of a plurality of batteries through a plurality of switch modules sequentially, switching on the switch module coupled to the battery with the lowest battery voltage to cause the battery with the lowest battery voltage to electrically connect to a charging unit, enabling the charging unit to supply power, and switching on the switch module corresponding to an attained battery voltage whenever the battery with the lowest battery voltage is charged to attain the battery voltage of one of the batteries.

### BACKGROUND OF THE INVENTION

### Field of the Invention

The present disclosure relates to charging technology and, more particularly, to a charging device and a method thereof.

### Description of the Prior Art

Portable electronic products are powered by batteries to ensure their portability. Green technology, which emerges in recent years, contributes to the increasing application of batteries in automobiles and motorcycles, such as petroleum-electric power systems, to address contemporary issues about dwindling energy resources and air pollution. In this regard, reusable and rechargeable batteries are all the rage, because they are environment-friendly and practical.

It is well aware that every battery has a specific service life that is disadvantageously reduced as a result of inappropriate charging behavior.

### SUMMARY OF THE INVENTION

In an embodiment, a charging method comprises the steps of: measuring a plurality of battery voltages of a plurality of batteries through a plurality of switch modules sequentially; switching on the switch module coupled to the battery with a lowest battery voltage, the battery being one of the batteries, to cause the battery with the lowest battery voltage to electrically connect to the charging unit; enabling the charging unit to supply power; and switching on the switch module corresponding to an attained battery voltage whenever the battery with the lowest battery voltage is charged to attain the battery voltage of one of the batteries. The switch modules are coupled between the charging unit and the batteries and adapted to change electrical connections between the charging unit and the batteries.

In an embodiment, a charging device comprises a port, a charging unit, a plurality of switch modules and a processing unit. The port is coupled to a plurality of batteries. A plurality of switch modules is coupled between the port and the charging unit and adapted to change an electrical connection between the charging unit and each said battery. The processing unit measures a plurality of battery voltages of the batteries sequentially through the switch modules, switches on the switch module coupled to the battery with a lowest battery voltage so as to instruct the battery with the lowest battery voltage to electrically connect to the charging unit, enables the charging unit to supply power, and switches on the switch module corresponding to an attained battery voltage whenever the battery with the lowest battery voltage is charged to attain the battery voltage of one of the batteries.

In conclusion, in an embodiment of the present disclosure, a charging device and a method thereof involve switching on switch modules during a charging process according to an increasing order of measured battery voltages such that the batteries will become parallel-connected only if they equal the battery with the lowest battery voltage in battery voltage. Therefore, during a charging process, the batteries do not experience any battery voltage difference therebetween which might otherwise cause the batteries to generate high currents and charge each other disadvantageously.

Fine features and advantages of the present disclosure are described below and illustrated by embodiments to allow persons skilled in the art to gain insight into the technical contents of the present disclosure and implement the present disclosure accordingly. By referring to the disclosure contained herein, the claims and the accompanying drawings, persons skilled in the art can understand related objectives and advantages of the present disclosure easily.

### BRIEF DESCRIPTION OF THE DRAWINGS

FIG. 1 is a block diagram of a charging device coupled to batteries according to an embodiment of the present disclosure;

FIG. 2 is a circuit diagram of the charging device in FIG. 1 according to an embodiment of the present disclosure;

FIG. 3 is a flowchart of a charging method according to an embodiment of the present disclosure;

FIG. 4 is a flowchart of step S10 in FIG. 3 according to an embodiment of the present disclosure; and

FIG. 5 is a flowchart of step S30 in FIG. 3 according to an embodiment of the present disclosure.

### DETAILED DESCRIPTION OF THE EMBODIMENTS

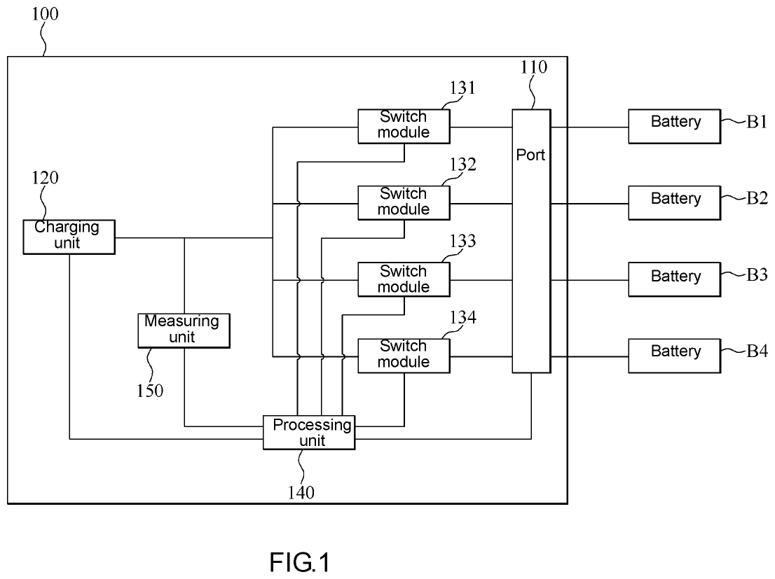

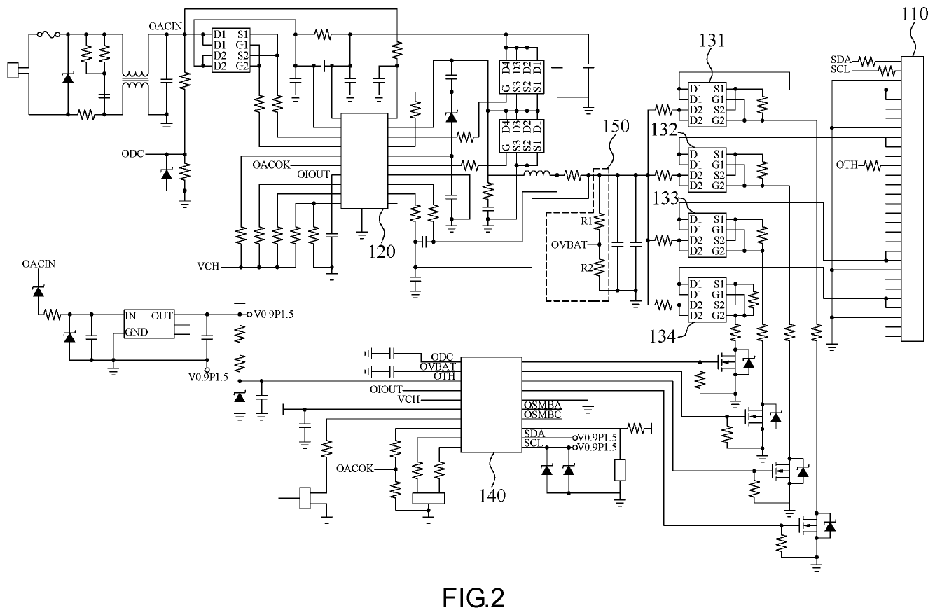

FIG. 1 is a block diagram of a charging device coupled to batteries according to an embodiment of the present disclosure. FIG. 2 is a circuit diagram of the charging device in FIG. 1 according to an embodiment of the present disclosure. Referring to FIG. 1 and FIG. 2, a plurality of batteries B1-B4 is connected to a charging device 100, and the charging device 100 charges the batteries B1-B4.

The charging device 100 comprises a port 110, a charging unit 120, a plurality of switch modules 131-134 and a processing unit 140. A plurality of switch modules 131-134 is coupled between the port 110 and the charging unit 120. The processing unit 140 is coupled to the port 110, the charging unit 120 and a plurality of switch modules 131-134.

The port 110 is used for connecting the batteries B1-B4 to the charging unit 120 via the switch modules 131-134. The switch modules 131-134 are controlled by the processing unit 140. Under the control of the processing unit 140, an electrical connection coupled between the charging unit 120 and the batteries B1-B4 coupled to the port 110 is switched on or off (i.e., built or severed) via the switch modules 131-134. The switch modules 131-134 correspond to the batteries B1-B4, respectively. As soon as the batteries B1-B4 are connected to the port 110, not only are the batteries B1-B4 electrically connected to the charging unit 120 through link paths built by the respective switch modules 131-134 (if the processing unit 140 switches on the respective switch modules 131-134), but the batteries B1-B4 also become parallel-connected because of the link paths built by the respective switch modules 131-134.

The switch modules 131-134 are initially open (OFF). Hence, despite a difference in battery voltage between the batteries B1-B4 when the batteries B1-B4 are connected to the port 110 of the charging device 100 and before the processing unit 140 switches on the switch modules 131-134, high-current discharge does not happen between the batteries B1-B4 because of the role of the switch modules 131-134 played in insulation, thereby protecting the batteries B1-B4 against damage.

In some embodiments, the batteries B1-B4 are each a single cell. In the other embodiments, the batteries B1-B4 each comprise a plurality of cells series-connected or parallel-connected according to respective power supply specifications of the batteries B1-B4. For example, in this specific embodiment, the batteries B1-B4 each comprise four series-connected cells with a battery voltage of 4.2 V. However, in the other specific embodiments, the batteries B1-B4 each comprise a plurality of series-connected cells with equal battery voltages, but the present disclosure is not limited to four-cell batteries.

In some embodiments, the batteries B1-B4 are lithium-ion batteries, phosphate lithium batteries, lithium polymer batteries, nickel-cadmium batteries, lead-acid battery or any type of batteries suitable for secondary charging and supplying power.

This specific embodiment is hereunder exemplified by four said batteries B1-B4, but the present disclosure is not restrictive of the number of batteries. Since the switch modules 131-134 control the electrical connection between the charging unit 120 and the batteries B1-B4, respectively, in a one-to-one manner, the switch modules 131-134 correspond in quantity to the batteries B1-B4 and thus are in the number of four. For example, it is feasible for the switch module 131 to change the electrical connection between the battery B1 and the charging unit 120, for the switch module 132 to change the electrical connection between the battery B2 and the charging unit 120, for the switch module 133 to change the electrical connection between the battery B3 and the charging unit 120, and for the switch module 134 to change the electrical connection between the battery B4 and the charging unit 120.

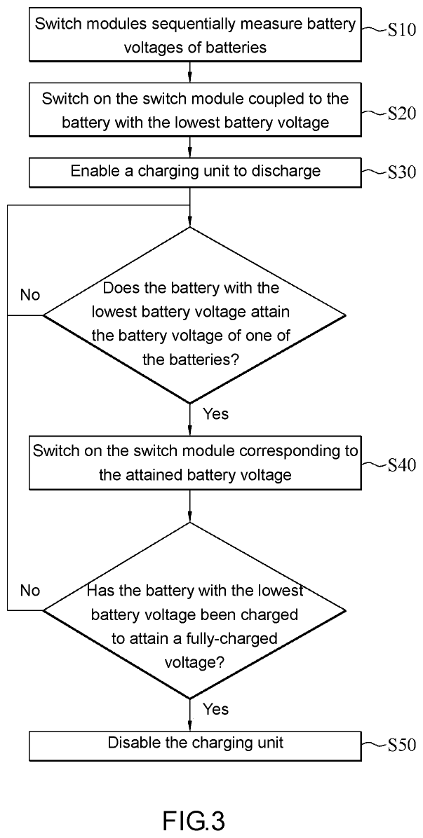

FIG. 3 is a flowchart of a charging method according to an embodiment of the present disclosure. Referring to FIG. 1 through FIG. 3, the processing unit 140 controls the charging unit 120 to perform parallel charging on a plurality of batteries B1-B4 sequentially with the charging method according to any embodiment of the present disclosure such that the batteries B1-B4 are equal in battery voltage when being fully charged.

In an embodiment of the charging method, the processing unit 140 switches on the switch modules 131-134 sequentially to measure battery voltages of the batteries B1-B4 (step S10) sequentially through link paths built by the switch modules 131-134. After measuring the battery voltages of the batteries B1-B4, the processing unit 140 identifies the battery voltage levels of the batteries B1-B4 and switches on the switch module coupled to the battery with the lowest battery voltage, thereby allowing the battery with the lowest battery voltage to electrically connect to the charging unit 120 through the link path built by the respective switch module (step S20). Afterward, the processing unit 140 enables the charging unit 120 to begin to supply power (step S30), and thus the charging unit 120 charges the battery with the lowest battery voltage through the built link path. The processing unit 140 switches on the switch module corresponding to an attained battery voltage whenever the battery with the lowest battery voltage is charged to attain the battery voltage of one of the batteries B1-B4 (step S40), thereby allowing the battery with the attained battery voltage to electrically connect to the charging unit 120 through the link path built by the switch module; meanwhile, through all the built link paths, the electrically connected batteries are simultaneously charged with power released from the charging unit 120. In an embodiment of the charging method, the processing unit 140 disables the charging unit 120 as soon as the battery with the lowest battery voltage is charged to attain a fully-charged voltage (step S50), so as to end the charging process.

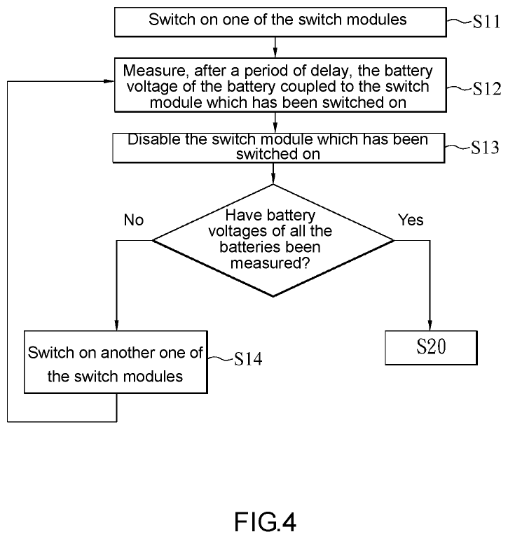

FIG. 4 is a flowchart of step S10 in FIG. 3 according to an embodiment of the present disclosure. Referring to FIG. 1 through FIG. 4, in an embodiment of step S10, the processing unit 140 switches on one of the switch modules 131-134 (step S11) and thus causes the switch module to build a link path between the corresponding battery and the charging unit 120. After a period of delay, the processing unit 140 begins measuring the battery voltage of the battery coupled to the switch module through the link path built in step S11 (step S12). Upon completion of the measuring process, the processing unit 140 disables the switch module switched on in step S11 (step S13) to sever the link path built by the switch module. Afterward, the processing unit 140 switches on another switch module (among the switch modules 131-134) which has not yet been switched on (step S14) in order to build another link path. At this point in time, the processing unit 140 goes back to step S12 to measure the battery voltage of the next battery. It is only when the processing unit 140 obtains the battery voltages of all the batteries B1-B4 connected to the port 110 through the switch modules 131-134 that the processing unit 140 ends step S10 and goes to step S20.

In an embodiment of step S12, the period of delay depends on the time required for the battery voltages of the batteries B1-B4 to stabilize with a view to enhancing the precision of the battery voltages measured by the processing unit 140. For example, the period of delay lasts three or six seconds, but the present disclosure is not limited thereto. In an embodiment of step S12, the period of delay does not even exist, and thus the processing unit 140 measures the battery voltages of the batteries immediately after the link paths have been built. In an embodiment, the processing unit 140 uses the measured voltage levels as the battery voltage levels of the batteries. In another embodiment, the processing unit 140 obtains battery voltage levels which are even more precise, using multiple sampling, cumulative additions, and averaging.

In an embodiment of step S12, the charging device 100 further comprises a measuring unit 150. The measuring unit 150 is coupled between the charging unit 120 and the switch modules 131-134. The processing unit 140 is coupled to the measuring unit 150. The measuring unit 150 measures the voltages of the batteries B1-B4 and provides information to the processing unit 140; hence, the processing unit 140 measures the battery voltages of the batteries B1-B4 through the measuring unit 150.

In some embodiments, the measuring unit 150 comprises at least two resistors R1, R2. The resistor R1 has a first end coupled to a plurality of switch modules 131-134 and the charging unit 120. The resistor R1 has a second end coupled to detection point OVBAT. The resistor R2 has a first end coupled to detection point OVBAT. The resistor R2 has a second end coupled to the ground. The processing unit 140 is coupled to detection point OVBAT to obtain the battery voltages of the batteries B1-B4 according to their voltages divided across the resistor R2 of the measuring unit 150 through the link paths built by the respective switch modules 131-134.

In an embodiment of step S10, the processing unit 140 detects whether the port 110 receives identity signals of the batteries B1-B4 to therefore determine whether the batteries B1-B4 are connected to the charging device 100. For example, the processing unit 140 is connected to the port 110 through connection point OTH and determines whether the batteries B1-B4 are connected to the charging device 100 according to whether connection point OTH receives the identity signals of the batteries B1-B4.

Upon determination that the batteries B1-B4 are connected to the charging device 100, the processing unit 140 determines how many batteries are connected to the charging device 100 and thereby identifies the number of times step S14 must repeat. For example, if the port 110 receives identity signals of the batteries B1-B4, the processing unit 140 confirms that step S14 must repeat thrice and that step S10 in its entirety ends immediately after the fourth instance of execution of step S13. For example, if the port 110 receives identity signals of three batteries, say, the batteries B1-B3, the processing unit 140 confirms that step S14 must repeat twice and that step S10 in its entirety ends immediately after the third instance of execution of step S13.

In an embodiment of step S10, never is more than one switch module switched on, and thus if the processing unit 140 detects a battery connected to the charging device 100 through the link path built by the switch module switched on, the link paths between the processing unit 140 and the other batteries are open.

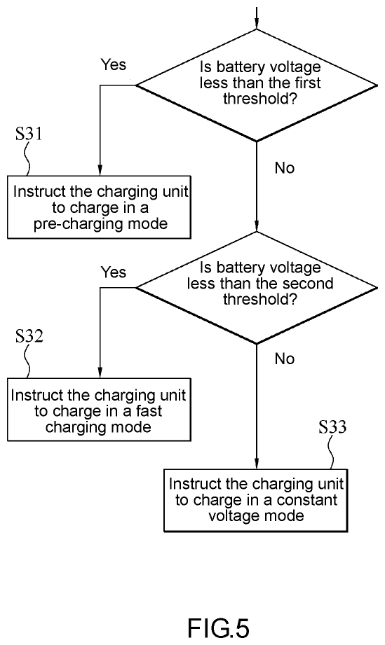

FIG. 5 is a flowchart of step S30 in FIG. 3 according to an embodiment of the present disclosure. Referring to FIG. 1 through FIG. 5, in an embodiment of step S30, the processing unit 140 determines a charging mode of the charging unit 120 according to the battery voltage of the battery with the lowest battery voltage. For example, if the battery voltage of the battery is less than a first threshold, the processing unit 140 instructs the charging unit 120 to charge in a pre-charging mode (step S31). If the battery voltage of the battery is greater than or equal to the first threshold but less than a second threshold, the processing unit 140 instructs the charging unit 120 to charge in a fast charging mode (step S32). If the battery voltage of the battery is greater than or equal to the second threshold, the processing unit 140 instructs the charging unit 120 to charge in a constant voltage mode (step S33). Both the first threshold and the second threshold are positive values. The second threshold is greater than the first threshold.

In some embodiments, the first threshold equals around 70% of the fully-charged voltage of the batteries, and the second threshold equals around 90% of the fully-charged voltage of the batteries. For example, if the batteries have a fully-charged voltage of 16.8 V, the first and second thresholds are 12 V and 16.4 V, respectively.

In the pre-charging mode, the charging unit 120 outputs a low, constant current to charge the batteries. In the fast charging mode, the charging unit 120 outputs a high, constant current to charge the batteries. In the constant voltage mode, the charging unit 120 operates at a constant voltage to charge the batteries. In some embodiments, the charging unit 120 outputs a low current of around 200 mA in the pre-charging mode, outputs a high current of 1 A in the fast charging mode, and operates in the constant voltage mode at a constant voltage equal to the fully-charged voltage of the batteries. For example, if the batteries have a fully-charged voltage of 16.8 V, the charging unit 120 operates in the constant voltage mode at a constant voltage of 16.4 V.

In an embodiment of step S50, the processing unit 140 not only disables the charging unit 120, but also disables the switch modules 131-134 to sever the link paths between the charging unit 120 and the batteries B1-B4.

An embodiment described below is about the charging method employed by the charging device 100 to charge the batteries B1-B4, wherein in step S10 the processing unit 140 measures and determines the battery voltages of the batteries B1, B2, B3 and B4 to be 10 V, 8 V, 14 V and 12 V, respectively, assuming that the fully-charged voltage of the batteries B1-B4 is 16.8 V, with the first threshold of 12 V, and the second threshold of 16.4 V.

First, in step S10 the processing unit 140 determines the battery with the lowest battery voltage to be the battery B2 and determines that battery voltage increases sequentially from the battery B2, the battery B1, the battery B4 to the battery B3.

Then, the processing unit 140 executes step S20 to switch on the switch module 132 so as to build the link path between the battery B2 and the charging unit 120. Since the battery voltage of the battery B2 is currently less than the first threshold, the processing unit 140 chooses to execute step S31 such that the charging unit 120 begins charging the battery B2 in the pre-charging mode through the link path built by the switch module 132.

The processing unit 140 measures the battery voltage of the battery B2 through the measuring unit 150. After measuring and determining that the battery voltage of the battery B2 being charged has increased from 8 V to the battery voltage (i.e., 10 V) of the battery B1, the processing unit 140 executes step S40 to switch on the switch module 131 and thereby build the link path between the battery B1 and the charging unit 120. At this point in time, not only have the battery B1 and the battery B2 become parallel-connected, but the charging unit 120 also charges the battery B1 and the battery B2 simultaneously. At this point in time, as a result of the parallel connection of the battery B1 and the battery B2, the strength of a charging current output by the charging unit 120 doubles, thereby speeding up the charging process. For instance, at this point in time, the charging current output by the charging unit 120 has increased from 200 mA to 400 mA because of the two parallel-connected batteries.

Upon determination that the battery B2 has been charged to attain the battery voltage (12 V) of the battery B4, the processing unit 140 executes step S40 again to switch on the switch module 134 and build the link path between the battery B4 and the charging unit 120. At this point in time, not only has the battery B4 become parallel-connected to the battery B1 and the battery B2, but the charging unit 120 also charges the battery B1, the battery B2 and the battery B4 simultaneously. Since the battery voltage of the battery B2 is currently equal to the first threshold, the processing unit 140 instructs the charging unit 120 to switch from the pre-charging mode to the fast charging mode in order to keep charging the battery B1, the battery B2 and the battery B4. Likewise, at this point in time, as a result of the parallel connection of the batteries, the strength of a charging current output by the charging unit 120 triples. For instance, at this point in time, the charging current output by the charging unit 120 has increased from 1 A to 3 A because of the three parallel-connected batteries.

Upon determination that the battery B2 has been charged to attain the battery voltage (14 V) of the battery B3, the processing unit 140 executes step S40 again to switch on the switch module 133 and build the link path between the battery B3 and the charging unit 120. At this point in time, not only has the battery B3 become parallel-connected to the battery B1, the battery B2 and the battery B4, but the charging unit 120 still charges the batteries B1-B4 simultaneously in the fast charging mode. Likewise, at this point in time, as a result of the parallel connection of the batteries, the strength of a charging current output by the charging unit 120 quadruples. For instance, at this point in time, the charging current output by the charging unit 120 has increased from 1 A to 4 A because of the four parallel-connected batteries.

The gradual increase in the battery voltages of the batteries B1-B4 ultimately culminates with the determination by the processing unit 140 that the batteries B1-B4 have been charged to attain the second threshold, and thus the processing unit 140 instructs the charging unit 120 to switch from the fast charging mode to the constant voltage mode in order to charge the batteries B1-B4. After measuring and determining that the battery voltage of the battery B2 has attained the fully-charged voltage (16.8 V), the processing unit 140 executes step S50 so as to finalize the process of charging the batteries B1-B4. Upon completion of the charging process, the batteries B1-B4 substantially attain the fully-charged voltages, respectively.

During a charging process, the batteries B1-B4 do not experience any battery voltage difference therebetween which might otherwise cause the batteries B1-B4 to generate high currents and charge each other disadvantageously, for a reason described below. It is only when the battery B1, the battery B3 and the battery B4 each substantially equal the battery B2 in battery voltage that the battery B1, the battery B3 and the battery B4 are electrically connected to the charging unit 120 through the link paths built by the switch module 131, the switch module 133 and the switch module 134, respectively, and parallel-connected to the battery B2.

In some embodiments, the processing unit 140 is an SoC chip, a central processing unit (CPU) or a micro-controller unit (MCU).

In conclusion, in an embodiment of the present disclosure, a charging device and a method thereof involve switching on switch modules during a charging process according to an increasing order of measured battery voltages such that the batteries will become parallel-connected only if they equal the battery with the lowest battery voltage in battery voltage. Therefore, during a charging process, the batteries do not experience any battery voltage difference therebetween which might otherwise cause the batteries to generate high currents and charge each other disadvantageously.

Although the present disclosure is disclosed above by preferred embodiments, the preferred embodiments are not restrictive of the present disclosure. Changes and modifications made by persons skilled in the art to the preferred embodiments without departing from the spirit of the present disclosure must be deemed falling within the scope of the present disclosure. Accordingly, the legal protection for the present disclosure should be defined by the appended claims.

What is claimed is:

1. A charging method, comprising the steps of:
measuring a plurality of battery voltages of a plurality of batteries through a plurality of switch modules sequentially, with the switch modules coupled between a charging unit and the batteries and adapted to change an electrical connection between the charging unit and each said battery;
switching on the switch module coupled to the battery with a lowest battery voltage, the battery being one of the batteries, to cause the battery with the lowest battery voltage to electrically connect to the charging unit;
enabling the charging unit to supply power; and
switching on the switch module corresponding to an attained battery voltage whenever the battery with the lowest battery voltage is charged to attain the battery voltage of one of the batteries.

2. The charging method of claim 1, wherein the step of enabling the charging unit to supply power comprises:
instructing the charging unit to supply power in a pre-charging mode if the battery voltage of the battery with the lowest battery voltage is less than a first threshold;
instructing the charging unit to supply power in a fast charging mode if the battery voltage of the battery with the lowest battery voltage is greater than or equal to the first threshold but less than a second threshold; and
instructing the charging unit to supply power in a constant voltage mode if the battery voltage of the battery with the lowest battery voltage is greater than or equal to the second threshold.

3. The charging method of claim 1, wherein the step of measuring the battery voltages of the batteries through the switch modules sequentially comprises:
switching on one of the switch modules;
measuring, after a period of delay, the battery voltage of the battery coupled to the switch module having been switched on;
disabling the switch module having been switched on; and
switching on another one of the switch modules.

4. The charging method of claim 1, wherein the step of measuring the battery voltages of the batteries through the switch modules sequentially comprises measuring the battery voltages of the batteries through a measuring unit disposed between the charging unit and the switch modules.

5. The charging method of claim 1, further comprising disabling the charging unit as soon as the battery with the lowest battery voltage is charged to attain a fully-charged voltage.

6. A charging device, comprising:
a port coupled to a plurality of batteries;
a charging unit;
a plurality of switch modules coupled between the port and the charging unit and adapted to change an electrical connection between the charging unit and each said battery; and
a processing unit for measuring a plurality of battery voltages of the batteries sequentially through the switch modules, switching on the switch module coupled to the battery with a lowest battery voltage so as to instruct the battery with the lowest battery voltage to electrically connect to the charging unit, enabling the charging unit to supply power, and switching on the switch module corresponding to an attained battery voltage whenever the battery with the lowest battery voltage is charged to attain the battery voltage of one of the batteries.

7. The charging device of claim 6, wherein according to a level of the battery voltage of the battery with the lowest battery voltage, the processing unit enables the charging unit to supply power according to a corresponding charging mode, wherein the processing unit instructs the charging unit to supply power in a pre-charging mode if the battery voltage is less than a first threshold, instructs the charging unit to supply power in a fast charging mode if the battery voltage is greater than or equal to the first threshold but less than a second threshold, and instructs the charging unit to supply power in a constant voltage mode if the battery voltage is greater than or equal to the second threshold.

8. The charging device of claim 6, wherein, when measuring the battery voltages of the batteries through the switch modules sequentially, the processing unit switches on one of the switch modules, measures, after a period of delay, the battery voltage of the battery coupled to the switch module having been switched on, disables the switch module having been switched on, and switches on another one of the switch modules.

9. The charging device of claim 6, further comprising a measuring unit coupled between the charging unit and the switch modules, wherein the processing unit instructs the measuring unit to measure the battery voltages of the batteries through the switch modules sequentially.

10. The charging device of claim 6, wherein the processing unit disables the charging unit when the battery with the lowest battery voltage is charged to attain a fully-charged voltage.
